(19) United States
(12) Patent Application Publication
(10) Pub. No.: US 2025/0024865 A1
(43) Pub. Date: Jan. 23, 2025

(54) System and Method to Improve the Efficiency and Quality of Cooking Grains

(71) Applicant: Nick Ovchinnikov, Rancho Santa Fe, CA (US)

(72) Inventor: Nick Ovchinnikov, Rancho Santa Fe, CA (US)

(21) Appl. No.: 18/707,169

(22) PCT Filed: Nov. 2, 2022
(86) PCT No.: PCT/US2022/048752

§ 371 Date: May 3, 2024

Related U.S. Application Data
(60) Provisional application No. 63/275,375, filed on Nov. 3, 2021.

(51) Int. Cl. A23L 7/196; A23L 5/10; B65G 49/02

(52) U.S. Cl. CPC A23L 7/1965; A23L 5/13; B65G 49/02; B65G 2201/0202

(57) ABSTRACT

A system and method to improve the efficiency and quality of cooking grains can include soaking the grains before cooking so that cook time is reduced. Soaking can be done carefully with a continuous soaker having a conveyor belt so that the grains are not agitated, pressed upon, or scooped. The grains can be cooked on a conveyor belt in a three-phase cooker that can reduce cook time and increase the quality of the cooked grains. A first phase can include forced steam that is blown into the cooker at the first phase. A second phase can include boiling water that is sprayed onto the grains. A third phase can include forced steam along with water drizzled onto the cooking rice.

### RELATED APPLICATIONS

This application claims the benefit of U.S. Provisional Patent Application Ser. No. 63/275,375, filed Nov. 3, 2021, entitled SYSTEM AND METHOD TO IMPROVE THE EFFICIENCY AND QUALITY OF COOKING GRAINS, the entire disclosure of which is herein incorporated by reference.

### FIELD OF THE INVENTION

This application relates to cooking grains, and more particularly, to systems and methods for cooking grains in an industrial setting.

### BACKGROUND OF THE INVENTION

The process of cooking rice on an industrial scale poses a number of problems. Soaking grains such as rice before cooking can lower cooking times and improve the taste, aroma, and texture of the finished product, but can also result in damage to the rice when performed using current technology. In cases where rice is pre-soaked before cooking, current technology uses large industrial batch soakers. In a typical batch method, rice is dumped into a large water tank with an opening valve at the bottom. The rice is submerged under water, and allowed to soak for approximately 30-45 minutes depending on the type of rice, and for various times depending on the different types of grains. This batch soaking often involves thousands of pounds of mixed rice and water in tanks that can include a 20-foot tall column of water. The 20-foot column of water results in differences in the pressure on the rice at different levels and, after draining, the rice is crushed under the weight of all of the rice above, with pressure increasing at deeper levels.

The rice is then removed from the soaking tanks and moved on to be cooked. However, rice, in particular, can be described as a membrane with solid starch inside and, after soaking and water absorption, the rice can become very fragile and very easily broken open, resulting in release of the starches. Under the current batch method, the soaked rice must be scooped out of the soak tank and manually transferred to the next process. This batch method can cause significant (40-50% or more of) rice breakage, and massive starch release due to the breakage caused by the pressure, agitation, scooping, etc. The free starch then affects the cooking process during further hot water and/or steam cooking and can make the cooking process ineffective, slow, and very uneven. Additionally, the involvement of people in the process of moving the soaked rice can increase the cost of production, and can increase agitation and breakage thereby decreasing the quality of the final product. Furthermore, contact between people and the grains can introduce pathogens and affect the food safety of the entire process.

The process of cooking rice on an industrial scale is also fraught with problems. Typical industrial continuous cookers use boiling water injection, and some cookers use steam injection, often as a second phase after a boiling water phase. In the case of pre-soaked American long-grain rice, cooking can take approximately 25 minutes, although this time can vary. The required cooking time increases significantly if rice is not soaked before cooking. The required cooking time for other types of rice and other types of grains can also vary significantly and also increases significantly if grains are not soaked before cooking. In addition grains that are cooked using a water-only cooking process, that is, a cooking process that does not include the use of steam, will typically have a soggy texture. In the case of rice that is not pre-soaked, rice cooked using a water-only process will typically be soggy or undercooked.

The additional cooking time required for unsoaked rice can also have a direct detrimental effect on the quality of the final product, as well as a negative effect on the cost and efficiency of the cooking process. Not only can the final texture of the rice be negatively affected, but the flavor and aroma of the rice can also be negatively affected. Aromatic substances, including, but not limited to 2-acetyl pyrroline, contribute to the fragrance and taste of rices such as basmati and jasmine. However, increased cooking time results in a loss of these aromatic compounds, which in turn results in rice that is less fragrant and less delicious.

Heat distribution can also be a major problem. In some cases, rice can have a high breakage rate of 50-60% or more, which results in massive starch release. That released starch, when combined with hot water, can make a glue-type substance in the rice layer. This not only affects the quality of the final product by having starch glue as part of the final food product, the starch glue substance can also result in uneven cooking as the hot water and/or steam are unable to fully penetrate the rice layer and cook each grain at the same rate to the same level of doneness. The use of steam can improve the result somewhat, but cannot fully overcome the detrimental effects of having a significant amount of free starch turned to glue within the rice layer. In the current state of the art, a cooking process can include a first stage using boiling water and a second stage using steam. However, the use of a steam cooking stage can cause the outer grains on the surface layer to dry out, so that the cooked rice has a rough, chewy texture on the surface. The outer layer of 2-3 grains, or top ⅛ inch at the upper surface are most affected.

Furthermore, the glue that results from free starch that has been released from broken grains can cause problems in the industrial process. The starch glue can adhere to conveyor belts and can clog holes in the belt that are necessary for proper water and air flow. This starch that adheres to the equipment can result in unsanitary conditions, and can require production to halt for periodic cleanings. Clogged vent holes in a conveyor belt can also contribute to uneven cooking, increased cooking times, and other problems.

Although the industrial preparation of rice and other grains has improved somewhat over the years, current technology still results in excessive breakage, starch glue mixed into the grains, soggy grains, undercooked grains, and chewy grains, just to name a few problems, sometimes with all of these problems present in a single batch of rice. It would be desirable to create a process for cooking rice that results in minimal rice breakage, minimal free starch, and rice that has been uniformly cooked to an ideal texture.

### SUMMARY OF THE INVENTION

The system and method for cooking rice and other grains as provided herein overcomes disadvantages of the prior art by minimizing breakage of the grains, minimizing free starch, decreasing cooking time, and producing rice that has been uniformly cooked to an ideal texture. The system and method for soaking rice, as provided herein, results in uniformly soaked rice and minimal pressure and agitation for the rice, which results in minimal breakage and minimal release of starches. As described herein, rice is soaked in a continuous process on an ultra-slow moving conveyor belt with the rice submerged under water for approximately 30 minutes, although the soaking time can vary for different rices and for different grains. At the end of the prescribed soaking time, the conveyor belt can gently lift the rice out of the shallow soak tank and allow the water to drain away, and then gently transfer the rice to the cooking equipment with minimal agitation, minimal breakage, and minimal starch release. The rice can be transferred directly to a cooker, or can be transferred to a smooth surface such as a polished stainless steel plate with continuous water spraying for prevention of drying and for reduction of friction with a smooth transfer of the rice to the conveyor surface of the cooker. Breakage can often be limited to a range of 0-4% breakage, thereby significantly improving the quality of the final product. This allows for high quality finished product on an industrial level, and can be applied to various grains that have not been produced at high quality on an industrial level up until now, including but not limited to super long grain basmati rice, white jasmine rice, lentils, and other challenging and vulnerable products.

The system and method provided herein also overcomes disadvantages of the prior art by introducing a three stage cooking process. Typical industrial cookers use boiling water injection for cooking, with some industrial cookers also using steam injection on the last stage of cooking. However, as described above, water-only cooking has various disadvantages and the addition of steam can result in a rough, chewy texture. The present method described herein overcomes these disadvantages by providing a 3-stage cooking process instead of the 2-stage process that is currently the best available. This three stage process starts with forced steam in the first stage, which improves on the low-pressure steam used in the final stage of the prior art. The forced steam results in an improved even heat distribution and an improved even cook through. The forced steam drastically improves heat exchange, and as a result of the improved heat exchange the cooking time is also significantly reduced. The forced steam results in improved quality of the finished cooked rice along with increased efficiency from the faster cook time. A second stage uses boiling water and then the third stage uses forced steam in combination with hot water being sprayed on the rice. The addition of sprayed water with the steam prevents hardening of the rice layer surface and keeps the product moist and at perfect texture through the entire thickness of the rice layer riding on the conveyor belt. This three-stage process results in cooking times being reduced by 20-25% or more, along with more even cooking and improved texture and taste.

After the rice is cooked and exits the cooking machine, this process further overcomes disadvantages of the prior art by providing a high-pressure water cleaning of the cooker belt from the inside out. As the belt loops back towards the start/entrance of the cooking machine, a power washer can spray the belt from the inside to remove broken grains and starches. In various embodiments, the power washer can slide back and forth continuously from one side of the belt to the other, spraying high pressure water through the openings in the belt to remove starches, broken grains, or any other debris so that the belt is clean and ready for the next cooking cycle without needing to stop the process for cleaning. This not only allows the cooking machine to run continuously for up to 72 hours before the bacterial growth hazard dictates the need to stop the process for cleaning, but also results in improved consistent cook through of the rice and improved quality of the final product.

In an embodiment, an exemplary continuous grain soaker can include a soaking tank, a continuous conveyor belt adapted to carry grains through the soaking tank, and a ramp, wherein the conveyor belt passes through the soaking tank and up the ramp, whereby water can be drained from the conveyor belt and back to the tank. The grain soaker can include a processor adapted to maintain temperature of water in the soaking tank in a range between approximately 65° Fahrenheit and approximately 75° Fahrenheit. The grain soaker can include a processor adapted to maintain a belt speed that results in a soaking time of approximately 30-50 minutes.

In an embodiment, an exemplary continuous grain cooker can include a continuous conveyor belt adapted to carry grains through the continuous grain cooker, a first forced steam zone, a boiling water zone, the boiling water zone comprising boiling water nozzles adapted to spray boiling water onto grains on the conveyor belt, a second forced steam zone comprising water drizzle nozzles adapted to drizzle water onto grains on the conveyor belt, and one or more forced steam blowers adapted to blow steam into the first forced steam zone and into the second forced steam zone under pressure. The continuous grain cooker can include a processor adapted to maintain a velocity of forced steam into the first forced steam zone of approximately 3.5 m/s. The continuous grain cooker can include a processor adapted to maintain a velocity of forced steam into the second forced steam zone of approximately 3.5 m/s. The continuous grain cooker can include a processor adapted to maintain a flow rate of drizzled water into the second forced steam zone.

A method of soaking grains can include depositing grains onto a conveyor belt of a grain soaker, moving the grains on the conveyor belt through a tank of water of the grain soaker; moving the grains on the conveyor belt upwards out of the tank of water on an upward sloping ramp section of the conveyor belt; allowing the excess water to drain away from the grains, and removing the grains from the grain soaker free of agitation or scooping of the grains.

### BRIEF DESCRIPTION OF THE DRAWINGS

The invention description below refers to the accompanying drawings, of which:

FIG. 1A is a perspective view of a continuous rice soaker, according to an illustrative embodiment;

FIG. 1B is a partially cut away side view showing the inner workings of the continuous rice soaker of FIG. 1A, according to the illustrative embodiment;

FIG. 1C is a top view of the continuous rice soaker of FIG. 1A, according to the illustrative embodiment;

FIG. 2A is a perspective view of a continuous rice cooker, taken from the entrance end of the cooker, according to an illustrative embodiment;

FIG. 2B is a partially cut away side view showing the inner workings of the rice cooker of FIG. 2A, according to an illustrative embodiment;

FIG. 2C is a perspective view of a continuous rice cooker, with the top outer shell lifted away to show forced steam blowers and ports, according to an illustrative embodiment;

FIG. 3 is a top view of a belt washer, according to an illustrative embodiment;

FIG. 4 is a flow diagram of an exemplary method for soaking and cooking rice, according to an illustrative embodiment;

FIG. 5 is an overview of a processing and controlling system for a rice soaker system, according to an illustrative embodiment; and

FIG. 6 is an overview of a processing and controlling system for a continuous rice cooker system, according to an illustrative embodiment.

### DETAILED DESCRIPTION

The system and method for preparing cooked grains, as described herein, includes an improved system and method for soaking grains, an improved system and method for cooking grains, and an improved system and method for cleaning a continuous grain cooking machine. Throughout this disclosure, the words “grain” and “rice” may be used interchangeably, however, it should be clear that the systems and methods described herein apply to a wide variety of grains, including various types of rice, lentils, chickpeas, quinoa, and other grains, along with other food products including peas and other vegetables.

Soaking rice before cooking the rice can shorten cooking time as the grains absorb water. Soaking hydrates the grains, and consequently, the amylose and amylopectin inside the starch granules absorb and swell. By soaking the grains and shortening the cooking time, grains that are noted for their fragrance, such as basmati rice and jasmine rice, have improved aroma and taste after they are cooked. Shortening the cooking time results in a reduced loss of aromatic compounds, such as 2-acetyl pyrroline, that naturally occur during the cooking process. However, soaked rice becomes fragile and can easily break and release starches. The released starch can have a negative effect on the cooking process and the quality of the final product.

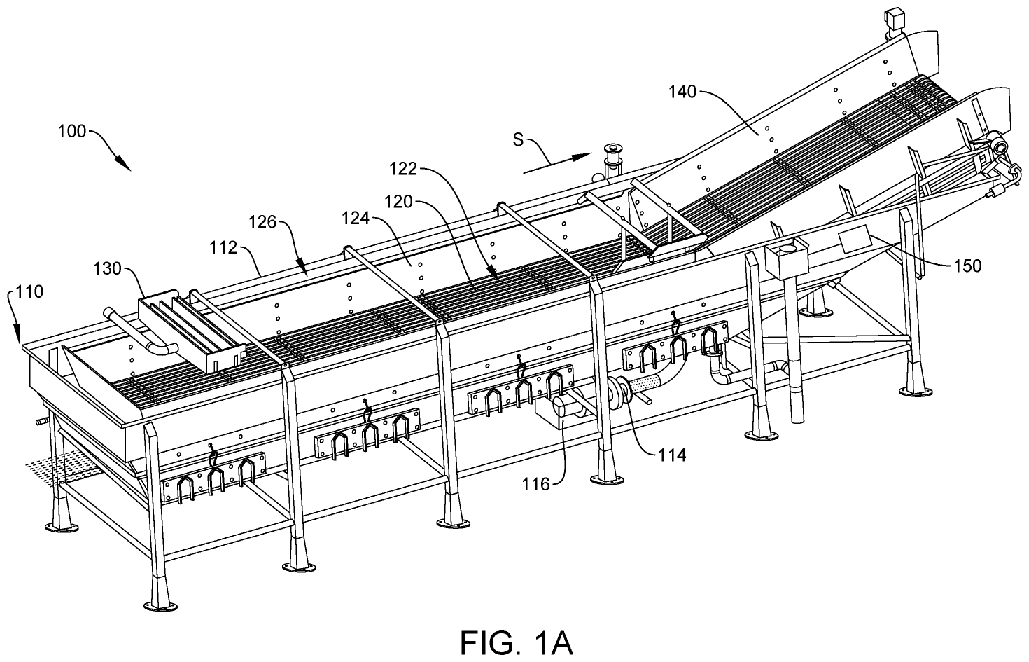

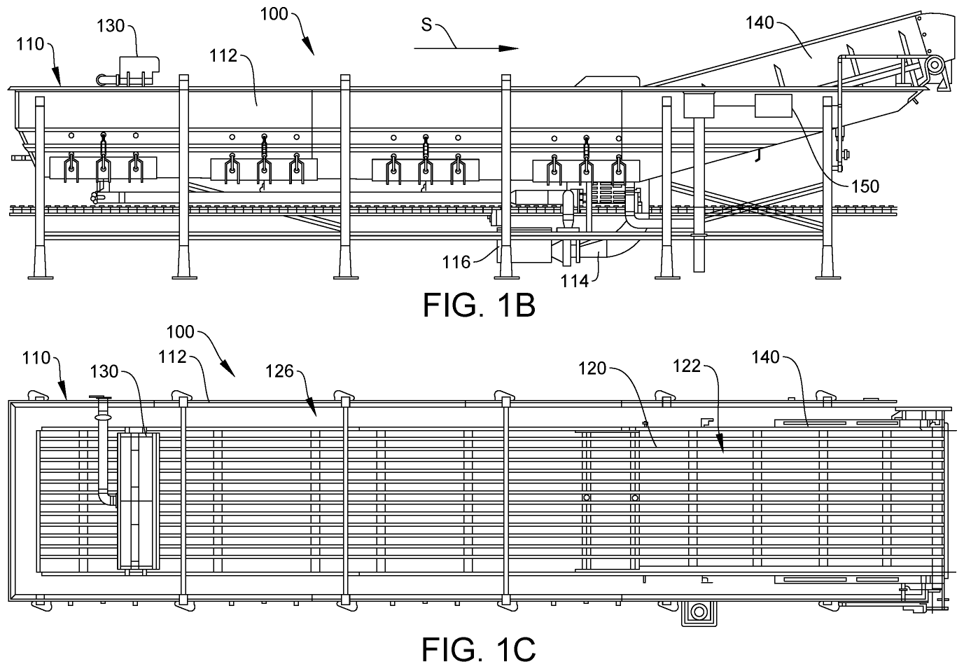

FIG. 1A is a perspective view of a continuous rice soaker, FIG. 1B is a partially cut away side view showing the inner workings of the continuous rice soaker of FIG. 1A, according to the illustrative embodiment, and FIG. 1C is a top view of the continuous rice soaker of FIG. 1A, according to an illustrative embodiment. Unlike traditional batch soaking methods, the continuous rice soaker significantly reduces agitation of the rice after soaking and significantly reduces the weight and pressure on the fragile soaked rice. A continuous rice soaker 100 can have an outer soaking tank 110 that can hold a recirculating bath of water. The tank can include sidewalls 112 and a water recirculating pump 114 which can keep the water cycling through filter 116 and constantly recirculating so that the water does not become stagnant. The continuous rice soaker 100 can have a controller 150 that can maintain, control, and adjust various parameters of the continuous rice soaker 100 to maintain predetermined operating conditions.

The water bath can be temperature controlled to achieve consistent water absorption yield. The water can be maintained at temperatures that are low enough to avoid cooking the grains at the soaking stage. By way of non-limiting examples, in various embodiments, the water can be maintained in a range between approximately 60° Fahrenheit and approximately 80° Fahrenheit. In various embodiments, the water can be maintained in a range between approximately 70° Fahrenheit and approximately 80° Fahrenheit. In various embodiments, the water can be maintained in a range that includes a low temperature of approximately 40° Fahrenheit. In various embodiments, the water can be maintained in a range that includes a low temperature of approximately 50° Fahrenheit. In various embodiments, the water can be maintained in a range that includes a low temperature of approximately 60° Fahrenheit. In various embodiments, the water can be maintained in a range that includes a low temperature of approximately 65° Fahrenheit. In various embodiments, the water can be maintained in a range that includes a low temperature of approximately 70° Fahrenheit. In various embodiments, the water can be maintained in a range that includes a low temperature of approximately 75° Fahrenheit. In various embodiments, the water can be maintained in a range that includes a high temperature of approximately 75° Fahrenheit. In various embodiments, the water can be maintained in a range that includes a high temperature of approximately 80° Fahrenheit. In various embodiments, the water can be maintained in a range that includes a high temperature of approximately 90° Fahrenheit. In various embodiments, the water can be maintained in a range that includes a high temperature of approximately 100° Fahrenheit.

Maintaining a consistent temperature in a low range allows for the grains to be soaked for longer periods of time, which results in rice with a sweeter flavour due to more efficient transfer of beta-starch into alpha-starch in the core of the rice grain. The continuous soaking method further contributes to allowing the rice to soaked longer, and be more thoroughly soaked, as compared to the traditional batch method, because the rice does not need to be scooped and moved from a soaker as it is in the batch method. The continuous soaking method described herein allows for the rice to be better soaked without resulting in broken grains, because the continuous soaking method allows the rice to be handled gently and transferred gently to the cooker without the need for scooping or other handling.

The rice soaker 100 can have a conveyor belt 120 that can move the grains through the soaking tank gently at ultra low speeds. By way of non-limiting examples, in an exemplary embodiment, the belt can move at ultra low speeds in a range between approximately 10 cm per minute and approximately 30 cm per minute, however, it should be clear that the belt speed can be controlled to result in the best soak time regardless of the length of the soaker. Longer soakers can use faster belt speeds compared to shorter soakers to result in the same soak time. The belt speed is directly related to the soak time for a tank of a given length, and the belt can move at a speed that results in soaking times in a range between approximately 10 minutes and approximately 50 minutes, however, the soaking times can vary for different grains. For rice, in various embodiments, the belt can move at a speed that results in a soaking time of approximately 20 minutes or more. In various embodiments, the belt can move at a speed that results in soaking times of approximately 45 minutes. This ultra-low belt speed helps to reduce agitation and breakage of the rice, resulting in an improved quality of the finished cooked rice. The conveyor belt can be constructed from a perforated material, constructed from a mesh, or other designs that allow water to pass through belt openings 122 while keeping the rice on the belt. In various embodiments, the belt 120 can be narrower than the tank 110, and an inner set of belt sidewalls 124 can help to keep the rice on the belt as the rice passes through the tank. This can provide a gap 126 between the tank sidewalls 112 and the belt sidewalls 124, which can improve water flow and circulation through the tank.

Rice can be slowly distributed onto the ultra slow conveyor belt 120 through a rice spreader 130. The conveyor belt moves along the direction of arrow S, and the rice spreader 130 distributes rice onto the conveyor belt as the conveyor belt passes under the spreader 130. In various embodiments, rice can be distributed onto the belt to a depth of approximately 5 inches to approximately 20 inches or more. In various embodiments, rice can be distributed onto the belt to a depth of approximately 6 inches. The rice can be distributed onto the belt to a depth that is approximately 3 inches below the surface of the water in the tank, thereby allowing the rice to expand as it absorbs water without rising above the surface. It should be clear that in various embodiments, the depth of the rice below the surface of the water can be different, and a wide range of depths is possible. It is important that the entire thickness of the rice layer remains submerged throughout the entire soaking process, but the specific depth is not important.

The rice can move very slowly through the tank 110 on the conveyor belt 120 for approximately 10 to 50 minutes, however, the speed of the belt can be adjusted to change soak times for different types of grains. In an embodiment the belt can move the grains through the tank for approximately 45 minutes. When the rice has travelled to the end of the soaking bath, the conveyor belt 120 can ride upward forming an inclined ramp 140, thereby lifting the rice out of the tank 110. Water can drain away from the rice through the belt openings 122, which can be holes in a mesh or other perforated surface. The water from the rice can then flow back down into the tank where it can continue to be recirculated and filtered.

This continuous rice soaker allows rice to be constantly distributed onto the belt at the entrance end of the rice soaker, a constant flow of rice to travel through the soaker, and a constant flow of soaked rice can exit the machine after the water is drained away. This continuous rice soaker produces rice that can be 96-100% intact with minimal breakage and minimal starch released due to the almost complete absence of agitation or pressure on the soaked rice. The rice can be soaked for extended periods of time to result in higher-quality finished cooked rice, and the rice can remain in the soaker for as long as necessary to create a smooth process from the beginning of soaking to the finished cooked product.

After soaking, the soaked rice can then be gently transferred to a continuous rice cooking machine. In various embodiments, the rice can be transferred from the conveyor belt 120 to a smooth surface such as a polished stainless steel plate with a continuous gentle water spray, which can reduce friction and help to move the rice onto the belt of the cooking machine. Transferring of the rice away from the soaker is done without (free of) agitating the grains and without (free of) scooping or shovelling of the grains.

The rice can be gently transferred to a conveyor belt of a continuous rice cooking machine. In various embodiments, the rice can be transferred to the conveyor of the continuous rice cooking machine at a depth of approximately 3 inches, although it should be clear that the advantages of the rice cooking machine described herein allow for the rice to be cooked uniformly and consistently regardless of the depth of the rice on the conveyor. When the rice is pre-soaked before entering the continuous rice cooking machine, cooking times can be significantly reduced. In various embodiments, the cooking time can be reduced by 20-25% or more compared to unsoaked rice, which can significantly improve the quality of the cooked rice. A continuous rice cooking machine can carry the rice through several phases of cooking. A first phase of cooking can subject the soaked rice to forced steam, a second stage of cooking can subject the rice to boiling water, and a third stage of cooking can subject the rice to forced steam coupled with hot water drizzled over the rice. In various embodiments, the hot water drizzled over the rice can be boiling, or nearly boiling. This process results in rice that is moist, uniformly cooked, and without a hardened or chewy exterior layer. The rice is cooked through with a perfect texture throughout the entire thickness of the rice grains and a perfect texture throughout all of the grains throughout the entire thickness of the layer of rice on the conveyor belt.

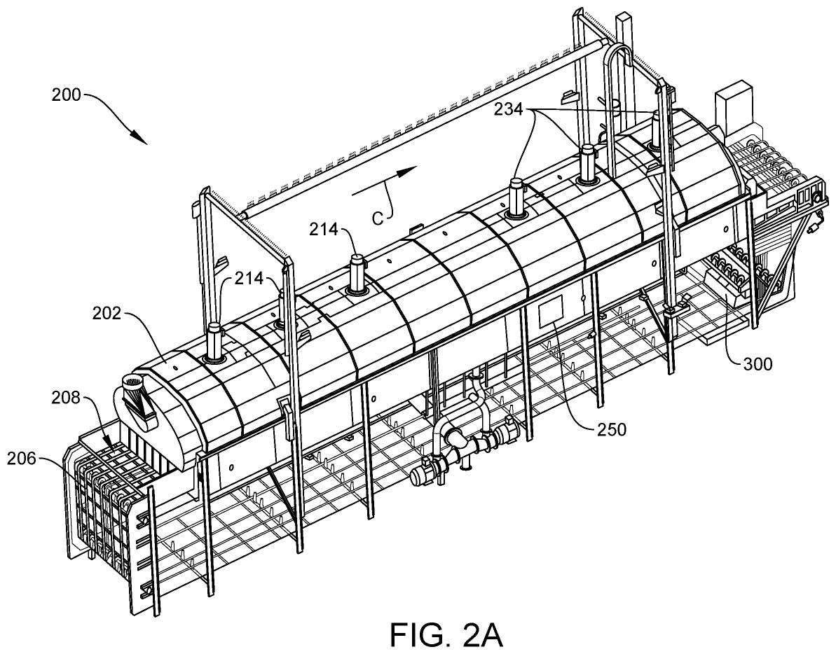

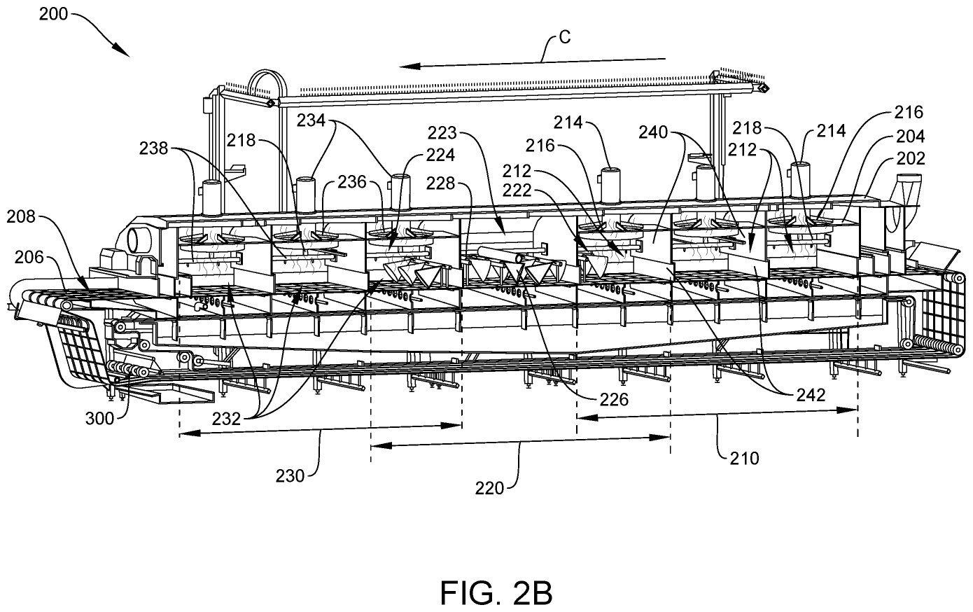

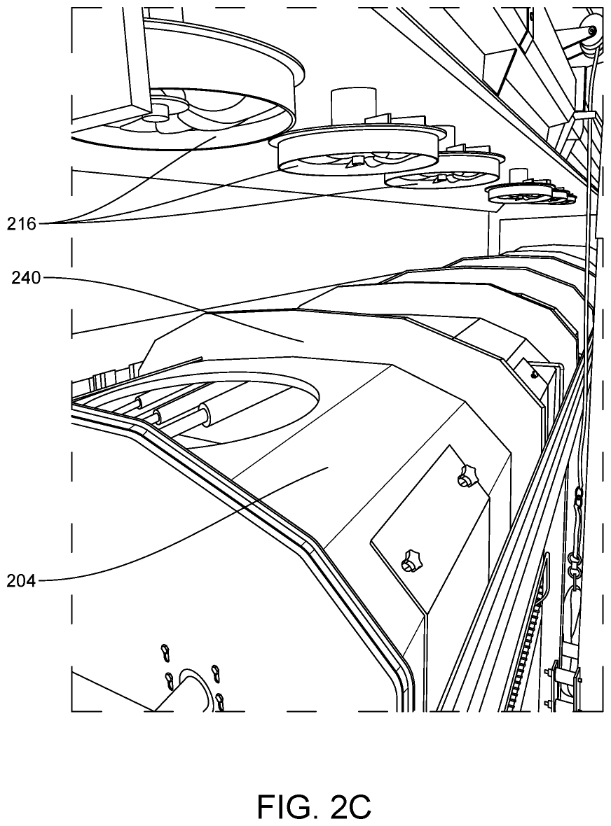

FIG. 2A is a perspective view of a continuous rice cooker, taken from the entrance end of the cooker, FIG. 2B is a partially cut away side view showing the inner workings of the rice cooker of FIG. 2A, and FIG. 2C is a perspective view of a continuous rice cooker, with the top outer shell lifted away to show forced steam blowers and ports, according to an illustrative embodiment. A rice cooker 200 can have a double layered shell that can include a top outer shell 202 and an inner shell 204. A conveyor belt 206 can carry the rice along the direction of arrow C through a first forced steam zone 210, a boiling water zone 220, and a second forced steam zone 230. Similar to the soaker conveyor belt, the cooker conveyor belt 206 can be constructed from a perforated material, constructed from a mesh, or other designs that allow water to pass through belt openings 208 while keeping the rice on the belt. The continuous rice cooker 200 can have a controller 250 that can maintain, control, and adjust various parameters of the continuous rice cooker 200 to maintain predetermined operating conditions.

In various embodiments, the first forced steam zone 210 can be approximately 3/7th of the cooker, the boiling water zone 220 can be approximately 1/7th of the cooker, and the second forced steam zone 230 can be approximately 3/7th of the cooker. Zones can be separated from neighbouring zones by dividers that can include walls 240, curtains 242, and/or other dividers. A zone can be divided into one or more chambers, and the chambers can be separated from neighbouring chambers by walls 240, curtains 242, and/or other dividers. In various embodiments, some or all of the chambers may not be fully separated from one or more neighboring chambers. In various embodiments, separations between chambers and/or between zones may include walls and/or curtains, partial walls and/or partial curtains, and/or no walls or curtains, or various combinations. In various embodiments, zones may be separated from neighboring zones, and a zone may consist of a single unseparated chamber. The walls and/or curtains can separate different cooking environments while allowing the rice to pass from one environment to the next on the belt. In various embodiments, a wall that separates zones can have a gap at the bottom that can be approximately 10 to approximately 12 inches to allow the belt and cooking rice to pass through the gap.

The first forced steam zone 210 can be divided into multiple steam chambers 212, and the chambers can be separated from neighbouring chambers by walls, curtains, and/or other dividers. Steam can be provided to the first forced steam zone 210 from an external source through a steam pipe 214. One or more blowers 216 can force the steam 218 into the first steam zone 210 under pressure. For the sake of clarity, steam is shown being forced into the first steam zone through blowers that are only located above the belt 206, however, it is specifically contemplated that steam can be forced into the chamber from below the belt, from the sides, etc. In various embodiments, a range from approximately 400 gallons to approximately 450 gallons of water per hour can be transformed into steam and forced into the first forced steam zone 210.

Steam can be blown into the first forced steam zone 210 at a velocity of approximately 4.0 m/s. Steam can be blown into the first forced steam zone 210 at a velocity of approximately 3.5 m/sec. Steam can be blown into the first forced steam zone 210 at a velocity of approximately 3.0 m/s. Steam can be blown into the first forced steam zone 210 at a velocity of approximately 2.5 m/s. The increase in pressure within the first forced steam zone 210 can be up to approximately 200 Pa compared to the ambient air pressure. The increase in pressure can be up to approximately 300 Pa compared to the ambient air pressure. The increase in pressure can be up to approximately 400 Pa compared to the ambient air pressure. The increase in pressure can be up to approximately 500 Pa compared to the ambient air pressure. The increase in pressure can be up to approximately 600 Pa compared to the ambient air pressure. The increased pressure improves heat distribution resulting in more consistent and uniformly cooked rice compared to historical methods, and also reduces cooking time by 20-25% or more. The forced steam and increased pressure can result in approximately uniform heat distribution throughout the layer of rice on the belt. The rice is partially cooked by the forced steam as it passes through the first forced steam zone 210.

The boiling water zone 220 can include multiple chambers, and in some embodiments the boiling water zone 220 can overlap with one or more of the forced steam zones 210 and 220. As shown in the illustrative embodiment of FIG. 2C, boiling water chamber 222 can also be a steam chamber 212, and boiling water chamber 224 can also be a steam chamber 232. One or more of the boiling water zone chambers 223 can have boiling water only, without steam. This boiling water chamber 223 can be free of steam blowers or forced steam. The boiling water 226 can enter the chambers from above through a system of pipes and nozzles 228. In various embodiments, boiling water 226 can be sprayed onto the rice below through the nozzles 228 at a flow rate that soaks and envelops the rice below in boiling water. In various embodiments, a range from approximately 250 gallons to approximately 300 gallons of boiling water can be sprayed into the boiling water zone 220 per hour. Excess water can drain through the rice and through the holes in the belt so that it can be collected, filtered, and recirculated.

The second forced steam zone 230 can be divided into multiple steam chambers 232, and the chambers can be divided by partial walls, curtains, and/or other dividers. Steam can be provided to the second forced steam zone 230 from an external source through a steam pipe 234. One or more blowers 236 can force the steam 218 into the second forced steam zone 230 under pressure. For the sake of clarity, steam is shown being forced into the second forced steam zone through blowers that are only located above the belt 202, however, it is specifically contemplated that steam can be forced into the chamber from below the belt, from the sides, etc. In various embodiments, a range from approximately 400 gallons to approximately 450 gallons of water per hour can be transformed into steam and forced into the first forced steam zone 230.

Steam can be blown into the second forced steam zone 230 at a velocity of approximately 4.0 m/s. Steam can be blown into the second forced steam zone 230 at a velocity of approximately 3.5 m/s. Steam can be blown into the second forced steam zone 230 at a velocity of approximately 3.0 m/s. Steam can be blown into the second forced steam zone 230 at a velocity of approximately 2.5 m/s. The increase in pressure within the second forced steam zone 230 can be up to approximately 200 Pa compared to the ambient air pressure. The increase in pressure can be up to approximately 300 Pa compared to the ambient air pressure. The increase in pressure can be up to approximately 400 Pa compared to the ambient air pressure. The increase in pressure can be up to approximately 500 Pa compared to the ambient air pressure. The increase in pressure can be up to approximately 600 Pa compared to the ambient air pressure. The increased pressure improves heat distribution resulting in more consistent and uniformly cooked rice compared to historical methods, and also reduces cooking time by 20-25% or more. The forced steam and increased pressure can result in approximately uniform heat distribution throughout the layer of rice on the belt. The rice is further cooked by the forced steam as it passes through the second forced steam zone 230.

The second forced steam zone 230 can also include water spray nozzles 238. Boiling water can be sprayed onto the rice through a system of pipes and nozzles 238. The method of spraying water onto the rice along with the steam in the second forced steam zone, instead of using steam alone, prevents hardening of the surface layer of rice, prevents the rice from becoming chewy, and keeps the rice moist and at a perfect texture. The top ⅛-¼ of an inch of rice (2-6 grains deep) that forms the top layer of the grains can be referred to as the surface layer.

As the rice reaches the end of the continuous rice cooking machine, the layer of rice on the belt can be approximately 6 inches to approximately 7 inches thick, and the entire layer of rice can be uniformly cooked throughout with uniform texture. The spraying of water prevents the rice at the top of the rice layer from having a harder texture than the rice at the bottom of the rice layer. The rice is fully and uniformly cooked when it exits the second forced steam zone 230 at the end of the continuous rice cooker 200 and is uniformly moist with a perfect texture. The finished product can then be collected from the belt at the end of the continuous rice cooking machine.

After the rice has been removed from the belt, the belt cycles back around under the machine and back to the beginning as rice is continuously added to the belt at one end and removed from the belt at the other end. However, after the cooked rice is removed from the belt at the second end, the belt may still have starches, individual grains of rice, and broken bits of rice still adhered to the belt. This can clog the openings of the belt and can also lead to unsanitary conditions and a bacterial growth hazard. Historically, this required that the equipment either be run under unsanitary conditions or the line must be halted regularly for cleaning. The present disclosure provides a novel system and method for washing the belt as part of the continuous cycle. This system and method for washing the belt creates more sanitary conditions and allows the machine to run continuously for 72 hours or more without the need to stop and clean the equipment.

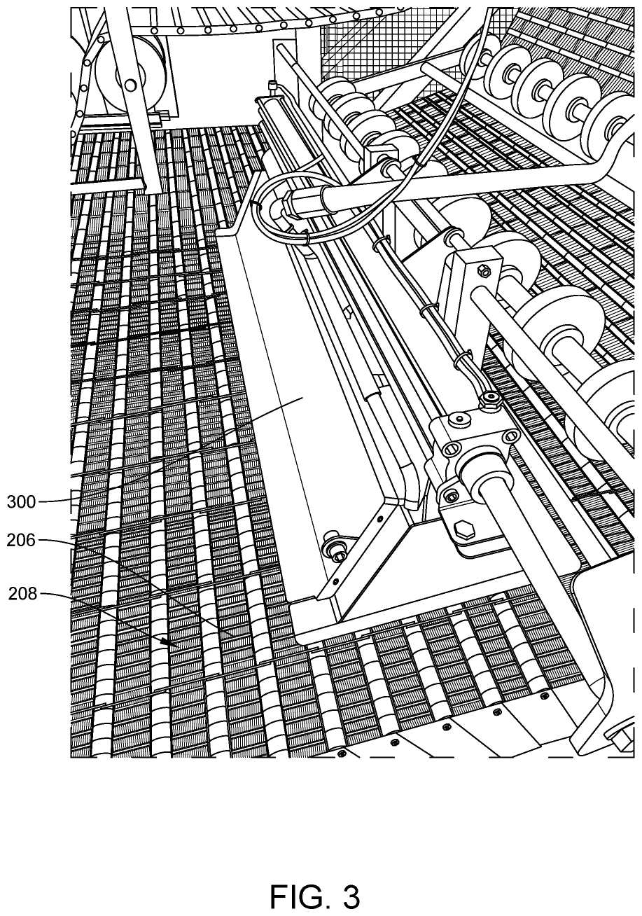

FIG. 3 is a top view of a belt washer, according to an illustrative embodiment. As shown in FIG. 3, along with FIG. 2A and FIG. 2D a belt washer 300 can clean the belt from the inside out. The belt washer can have a series of nozzles that spray water through the belt openings 208 in the belt 206 from the inside to clean away the remnants of the cooking process, including starches, grains, and grain fragments. The belt moves through the machine at a low speed, and it passes under the belt washer at a sufficiently low speed to allow all of the remnants of the cooking process to be washed away by high pressure water being forced through the nozzles of the belt cleaner and through the belt.

The belt washer 300 can be a reciprocating belt washer that can move from side to side along the width of the belt. A reciprocating belt washer can cover a washing region that extends from one side of the belt to the other as the belt passes through the washing region. Because the belt moves slowly through the continuous cooking machine, the reciprocating belt washer can move back and forth from one side to the other and can effectively clean all of the belt as it passes through the washing region. By reducing the washing area of the belt washer to a limited portion of the washing region, the water pressure can be concentrated onto a smaller area, resulting in more effective cleaning and a more efficient use of water.

In various embodiments, a belt washer could be positioned to spray water from the outside surface of the belt, where the rice had been sitting, through the belt towards the inside. In various embodiments, one or more belt washers can be positioned to spray water from the inside out and/or from the outside in. As the belt exits the washing region it is now clean and sanitary and ready to re-enter the first forced steam zone with fresh rice.

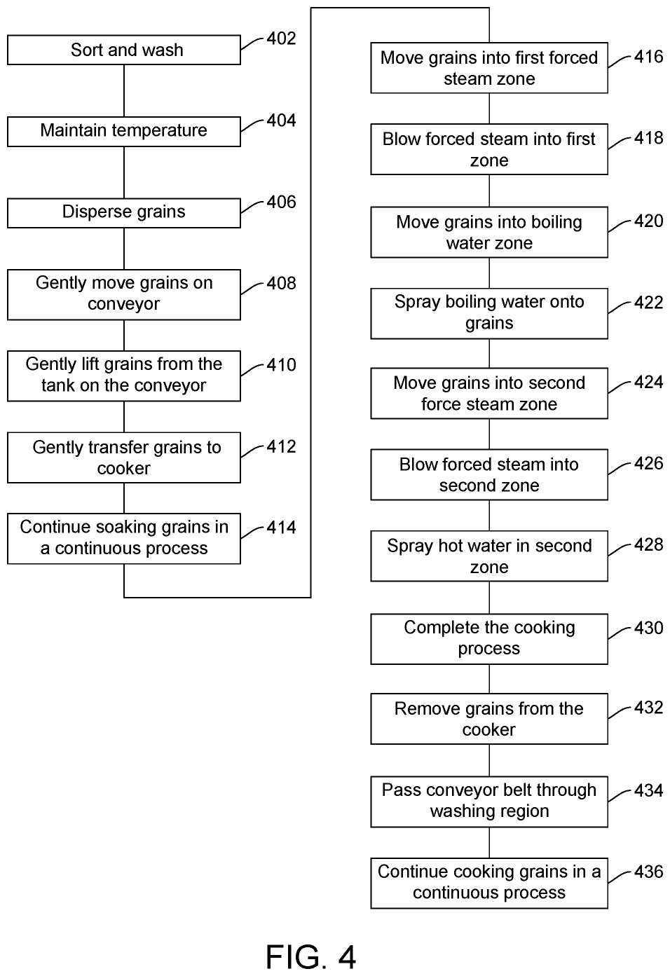

FIG. 4 is a flow diagram of an exemplary method for soaking and cooking grains, according to an illustrative embodiment. At box 402, grains can be sorted and washed in a preliminary step. At box 404, water in a soaking tank is maintained at a controlled temperature within a predetermined range. At box 406, grains can be dispersed onto an ultra-slow moving conveyor belt that can be submerged in the soaking tank. At box 408 the grains are moved on the conveyor belt very slowly and very gently through the soaking tank. Care is taken to avoid agitating the grains or putting pressure on the grains as they are moved through the soaking tank. The process is free of agitation or pressure on the grains. The grains can be moved through the tank slowly until they have been submerged for a predetermined period of time. At box 410, the conveyor belt can travel up a ramp so that grains are lifted out of the water after soaking. Water can drain away from the grains through openings in the conveyor belt. Care is taken to avoid agitating the grains or putting pressure on the grains. The process is free of agitation or pressure on the grains. At box 412, the grains are gently transferred onto a conveyor belt of a continuous grain cooking machine. Care is taken to avoid agitating the grains or putting pressure on the grains as they are moved through the soaking tank. The process is free of agitation or pressure on the grains. In various embodiments, the grains can be transferred from the conveyor belt to a smooth surface such as a polished stainless steel plate with a continuous gentle water spray, which can reduce friction and help to move the grains onto the belt of the cooking machine. Transferring of the grains is done without (free of) scooping or shovelling of the grains. At box 414, the continuous grain soaker continues to soak grain without (free of) pauses or stoppages.

At box 416, the grains on the conveyor belt of the continuous cooking machine are moved into a first forced steam zone. At box 418, forced steam is blown from a blower into the first forced steam zone at a predetermined velocity resulting in an increase in pressure within the first forced steam zone. The forced steam produces an even heat distribution within the first forced steam zone and causes cooking of the grains to begin. At box 420, the conveyor belt moves the grains into the boiling water zone. At box 422, boiling water is sprayed onto the partially cooked grains, and the partially cooked grains are further cooked by the boiling water. At box 424, the conveyor belt moves the grains into a second forced steam zone. At box 426, forced steam is blown from a blower into the second forced steam zone at a predetermined velocity resulting in an increase in pressure within the second forced steam zone. The forced steam produces an even heat distribution within the second forced steam zone and causes cooking of the grains to continue. At box 428, hot water is sprayed on the grains while they are being subjected to forced steam in the second forced steam chamber. The hot water spraying prevents any of the rice from hardening or becoming chewy. The rice is cooked uniformly to an ideal texture and is free of any hardness or chewiness. At box 430, complete the cooking process after a predetermined period of time that can be 20-25% less than the cooking time used by traditional methods. At box 432, the cooked grains are removed from the continuous grain cooking machine. At box 434, the conveyor belt passes through a belt washing region, and a belt washer washes away any remnants of the cooking process by spraying forced water through the belt from the inside out. At box 436, the continuous grain cooker continues to cook grain without (free of) pauses or stoppages.

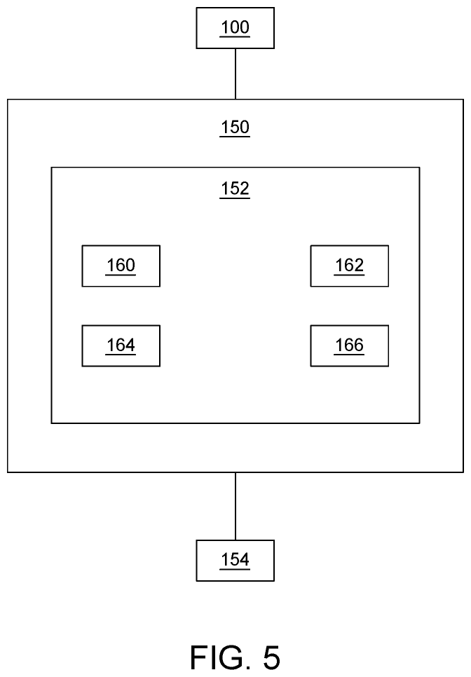

FIG. 5 is an overview of a processing and controlling system for a rice soaker system, according to an illustrative embodiment. The controller 150 can maintain, control, and adjust various operating parameters of the continuous rice soaker 100 to maintain predetermined operating conditions. The controller can maintain, control, and adjust parameters including the temperature of the water bath, the speed of the conveyor belt and soak time, the rate of rice being spread by the rice spreader, and the flow rate of the recirculating pump. The controller 150 includes a processor 152, and processor 152 can have a water bath temperature control module 160, a conveyor belt speed and soak time control module 162, a rice spreader spread rate control module 164, and a recirculating pump flow rate control module 166. The controller 150 can be operatively connected to a user interface 154 that can include a keyboard, screen, and/or touchscreen.

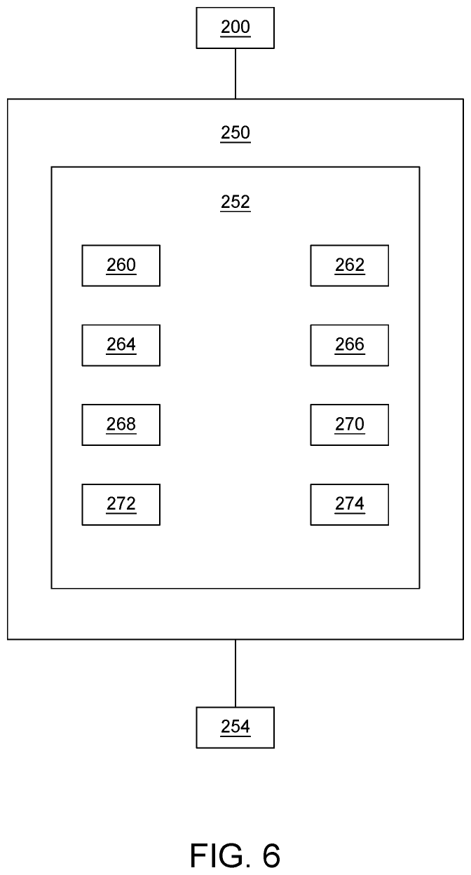

FIG. 6 is an overview of a processing and controlling system for a continuous rice cooker system, according to an illustrative embodiment. The controller 250 can maintain, control, and adjust various operating parameters of the continuous rice cooker 200 to maintain predetermined operating conditions. The controller can maintain, control, and adjust parameters including velocity of forced steam into the first forced steam zone, temperature of forced steam at the first forced steam zone, flow rate of boiling water through the nozzles into the boiling water zone, velocity of forced steam into the second forced steam zone, temperature of forced steam at the second forced steam zone, temperature of water drizzled onto the rice in the second forced steam zone, flow rate of water drizzled onto the rice in the second forced steam zone, and conveyor belt speed and cook time. Velocity of forced steam into the first forced steam zone and the second forced steam zone can be controlled by controlling the speed of blowers that deliver steam into the forced steam zone. In various embodiments, there can be three blowers in each forced steam zone, and each can be controlled separately. The controller 250 includes a processor 252, and the processor 252 can have a first forced steam zone steam velocity control module 260 that can control blower speeds, a first forced steam zone steam temperature control module 262, a boiling water flow rate control module 264, a second forced steam zone steam velocity control module 266 that can control blower speeds, a second forced steam zone steam temperature control module 268, a second forced steam zone drizzled water temperature control module 270, a second forced steam zone drizzled water flow rate control module 272, and a conveyor belt speed and cook time control module 274. The controller 250 can be operatively connected to a user interface 254 that can include a keyboard, screen, and/or touch screen.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein, is merely illustrative of the application of the principles of the present invention. For example, in various embodiments, a single conveyor belt can pass through both the soaker and the cooker, so that the grains do not need to be moved from one belt to another or otherwise agitated from the time they are initially dispersed on the soaking belt until they are a completely cooked finished product. Also, as used herein, various directional and orientational terms (and grammatical variations thereof) such as “vertical,” “horizontal,” “up,” “down,” “bottom,” “top,” “side,” “front,” “rear,” “left,” “right,” “forward,” “rearward,” and the like, are used only as relative conventions and not as absolute orientations with respect to a fixed coordinate system, such as the acting direction of gravity. Additionally, where the term “substantially” or “approximately” is employed with respect to a given measurement, value, or characteristic, it refers to a quantity that is within a normal operating range to achieve desired results, but that includes some variability due to inherent inaccuracy and error within the allowed tolerances (e.g. 1-2%) of the system. Note also, as used herein the terms “process” and/or “processor” should be taken broadly to include a variety of electronic hardware and/or software-based functions and components. Moreover, a depicted process or processor can be combined with other processes and/or processors or divided into various sub-processes or processors. Such sub-processes and/or sub-processors can be variously combined according to embodiments herein. Likewise, it is expressly contemplated that any function, process, and/or processor herein can be implemented using electronic hardware, software consisting of a non-transitory computer-readable medium of program instructions, or a combination of hardware and software. Accordingly, this description is meant to be taken only by way of example, and not to otherwise limit the scope of this invention.

1. A continuous grain soaker comprising:
a soaking tank with water inside the soaking tank;
a continuous conveyor belt adapted to carry grains through the water in the soaking tank; and
a ramp, wherein the conveyor belt passes through the soaking tank and up the ramp, whereby the water can be drained from the conveyor belt and back to the tank.

2. The grain soaker of claim 1, wherein a temperature of the water in the soaking tank is a range between approximately 65° Fahrenheit and approximately 75° Fahrenheit.

3. The system of claim 1, wherein a belt speed of the conveyor belt is maintained at a speed that results in a soaking time in a range between approximately 15 to approximately 50 minutes.

4. A continuous grain cooker comprising:
a continuous conveyor belt adapted to carry grains through the continuous grain cooker;
a first forced steam zone;
a boiling water zone, the boiling water zone comprising boiling water nozzles adapted to spray boiling water onto grains on the conveyor belt;
a second forced steam zone; and
one or more forced steam blowers adapted to blow steam into the first forced steam zone and into the second forced steam zone under pressure.

5. The continuous grain cooker of claim 1, wherein the first forced steam zone blowers maintain a velocity of forced steam into the first forced steam zone of approximately 3.5 m/s.

6. The continuous grain cooker of claim 1, wherein the second forced steam zone blowers maintain a velocity of forced steam into the second forced steam zone of approximately 3.5 m/s.

7. The continuous grain cooker of claim 1, wherein the second forced steam zone further comprises water drizzle nozzles that are adapted to drizzle water onto the rice as the rice passes through the second forced steam zone.

8. The continuous grain cooker of claim 7, wherein the water drizzle nozzles of the second forced steam zone maintain a flow rate of drizzled water into the second forced steam zone of approximately 1 L/s.

9. A method of soaking grains comprising:
depositing grains onto a conveyor belt of a grain soaker;
moving the grains on the conveyor belt through a tank of water of the grain soaker;
moving the grains on the conveyor belt upwards out of the tank of water on an upward sloping ramp section of the conveyor belt;
allowing the excess water to drain away from the grains;
and removing the grains from the grain soaker free of agitation or scooping of the grains.

10. The method of claim 9, wherein the grains are a rice, and moving the rice on the conveyor belt through the tank of water further comprises moving the rice through the tank of water for more than 20 minutes, thereby resulting in an increase in the sweetness of the rice after the rice is cooked.
